(19) United States
(12) Patent Application Publication
(10) Pub. No.: US 2007/0174305 A1
(43) Pub. Date: Jul. 26, 2007

(54) Method to reduce the number of copies of values in procedural language

(75) Inventor: Gustavo Arocena, Toronto (CA)

Correspondence Address: SAWYER LAW GROUP LLP, P.O. BOX 51418, PALO ALTO, CA, 94303, US

(73) Assignee: International Business Machines Corporation, Armonk, NY (US)

(21) Appl. No.: 11/327,591

(22) Filed: Jan. 6, 2006

(51) Int. Cl. G06F 7/00

(52) U.S. Cl. 707/100

(57) ABSTRACT

A method and system is presented to reduce the number of copies in the execution of routines written in a procedural language with by-value assignment semantics. During routine compilation, each statement within the routine is classified as being copy-sensitive or not, depending on the operations it contains. During routine execution, a lazy copy strategy is used to determine when variables should be copied: copies are not performed on variable assignment, but instead are delayed until variables are used in copy-sensitive statements. If a variable is never used in a copy-sensitive statement, then it will never be copied, thus saving computation time and storage.

### FIELD OF THE INVENTION

The present invention relates generally to procedural languages used in database systems and more specifically to procedural languages that provide an assignment operation with by-value semantics.

### BACKGROUND OF THE INVENTION

Database systems are computer programs for the efficient storage and retrieval of large volumes of data. The commands or statements to store data in and retrieve data from a database system are usually expressed in a high level programming language, such as the well known Structured Query Language (SQL), defined by the ISO/IEC standard 9075.

Sometimes, several SQL statements are combined together in routines using control structures, such as IF-THEN-ELSE and WHILE-DO, which are not part of the core SQL language. These control structures are commonly referred to as procedural SQL. The SQL standard defines one such procedural language, known as SQL/PSM, but several other similar procedural languages are widely known.

Besides statements, routines usually contain variable declarations. Variables allow statements to save one or more temporary values, so that other statements can use them later on. Each statement in a routine has zero or more input variables (the variables it uses) and zero or more output variables (the variables it assigns a value to).

When routines are entered into a database system, they undergo a process known as compilation, by which they are translated from a human-readable language such as SQL to a low level representation that facilitates the efficient execution of the routines by the system. The parts of a database system that perform the compilation and execution of routines and the statements within them are known as the compiler and the run-time processor, respectively.

Data items in a database, such as names, telephone numbers and prices are represented as values of data types such as integer numbers, strings, etc. In recent years, many database systems have started to provide the XML data type to represent complex data values. Database systems in which values of the XML data type are represented according to the XQuery 1.0 and XPath 2.0 Data Model (which is an industry standard defined in http://www.w3.org/TR/xpath-datamodel/.) or a similar model are beginning to be utilized extensively. Recent versions of the SQL standard incorporate an XML type based on such a model. Part 14 of the SQL standard, commonly referred to as SQL/XML is devoted specifically to the use of XML in SQL.

Each data type provides a set of operations that can be used on values of that type. SQL/XML defines a number of XML operations such as XMLQUERY, XMLCONCAT, etc., that have XML values as input and/or output.

XML Data Model

According to the XQuery 1.0 and XPath 2.0 Data Model, values of the XML data type are ordered sequences of zero or more items, where each item can be either an atomic value or a node. Atomic values are values with no subcomponents; for example, integer numbers or strings. Nodes, on the other hand, form a tree that consists of a root node plus zero or more children nodes, where each child node can have zero or more children, and so on. Each node has a unique identity. Every node in an instance of the data model is unique: a node is identical to itself, and not identical to any other node. Atomic values do not have identity; every instance of the integer value “5”, for example, is identical to every other instance of the integer value “5”. A given node may occur more than once in a sequence. When manipulating XML values with a language such as XQuery, given a node, it is possible to obtain its parent node. If a node N is a root node, its parent is the empty sequence. Otherwise, the parent of N is the node that is the immediate ancestor of N in the tree to which N belongs.

FIG. 1 is a graphical representation of the above-identified concepts. The comma-separated list 12 at the top left corner of FIG. 1 is a graphical representation of an XML sequence containing 5 items. Each of these items represents a city in Canada, Mexico or the US. NOTE: the small circles in sequence 12 and the dotted lines starting at them are just a way of facilitating the graphical representation of the sequence; the actual items of the sequence are then ones at the end of the dotted lines. Items for cities within the US 14 and 16 are strings containing the city name and state, whereas items for cities in Canada or Mexico 22 and 26 are nodes with two children; the first child 18a and 20a contains the city name and state or province, and the second child 18b and 20b contains the country name. The circles 22, 24 and 26 represent nodes, and the number within each circle 22, 24 and 26 represents the node's identity. As can be seen, the first and fourth items in the sequence 12 are duplicates; both refer to node 26, which represents Toronto. Furthermore, it is seen that the node 22 representing Cancun has a parent node 24, which is not an item in the sequence 12.

XML Copy Operation

During the execution of programs, it is often necessary to create copies of the data values being manipulated. In particular, as will be explained shortly, certain assignment operations involve the creation of copies. According to the definition of XML copy in the SQL standard, and unlike what happens with values of other data types available in SQL, a copy of a value of type XML may not be identical to the original value. In fact, when a copy of a non-atomic XML value is created, the copy and the original value differ in several ways, including:

1. The nodes in the copy have different identities than the nodes in the original value. This is simply a consequence of the fact that, according to the data model, different nodes must have different identities.

2. The parent of the root node of each item in the copy is always empty. This is because the copy operation copies a node and its descendants, but not its ancestors.

3. The copy never contains duplicate references to a given node. This is because each item in a sequence is copied independently of other items. Therefore, if a sequence contains two or more duplicate references to a given node, a copy will contain a new node for each of these duplicate references.

On the other hand, when an atomic value is copied, the copy and the original value are identical in every respect.

FIG. 2 is a graphical representation of a value that is a copy of the XML value depicted in FIG. 1. When comparing FIG. 1 and FIG. 2, it can be observed that all the nodes in FIG. 2 have different identities than the nodes in FIG. 1. As is seen, there are now three nodes 54, 56 and 58. It can also be observed that the first and fourth items of the value in FIG. 2 are no longer duplicate references to a node representing Toronto; instead, they refer to two different nodes for Toronto (nodes 54 and 58). Finally, node 56 representing Cancun has no parent node as is shown in FIG. 1 (in FIG. 1, node 24 is the parent of node 22, but in FIG. 2, node 56 does not have a parent node.)

Therefore, FIG. 2 illustrates the three points made earlier. Namely,

1. The nodes in the copy have different identities than the nodes in the original value.

2. The parent of the root node of each item in the copy is always empty.

3. The copy never contains duplicate references to a given node.

Assignment Operation

An operation frequently executed in procedural programs is assignment, which associates the value computed by an expression with a variable. Following standard programming language terminology, an assignment operation consists of two parts, usually referred to as left-hand side (LHS) and right-hand side (RHS). The LHS is a variable name, and the RHS is an expression that, when evaluated, produces the value for the variable. For example, in the assignment statement
SET A=B+5;
A and B are integer variables, A is the LHS and “B+5” is the RHS.

Note: the term “assignment” includes all operations in which a variable is assigned a new value. In SQL/PSM, such operations include: the SET statement illustrated above, the FETCH-INTO statement, the SELECT-INTO statement and the CALL statements with OUT or INOUT parameters.

In the SQL language, assignments to variables of type XML can have either by-value semantics or by-reference semantics. With by-reference semantics, the value assigned to the variable is the value produced by the expression. On the other hand, with by-value semantics, the value assigned to the variable is a copy of the value produced by the expression.

Assignment with by-reference semantics is, in principle, more efficient than assignment with by-value semantics, as the former doesn't require a copy. However, it is generally accepted that assignment with by-value semantics leads to programs that are easier to understand and maintain. Hence, it is expected that many programs that manipulate XML data will use assignments with by-value semantics. It is therefore important to find efficient ways of implementing this operation.

Accordingly, what is needed is a system and method for reducing the number of copies of values and therefore improving the efficiency of operation of a procedural language in a database system. The method and system should be easily adapted and implemented from existing databases. The system and method should also be cost-effective. The present invention addresses such a need.

### SUMMARY OF THE INVENTION

A method and system is presented to reduce the number of copies in the execution of routines. During routine compilation, each statement within the routine is classified as being copy-sensitive or not, depending on the operations it contains. During routine execution, a lazy copy strategy is used to determine when variables should be copied: copies are not performed on variable assignment, but instead are delayed until variables are used in copy-sensitive statements. If a variable is never used in a copy-sensitive statement, then it will never be copied, thus saving computation time and storage.

### BRIEF DESCRIPTION OF THE DRAWINGS

FIG. 1 is a graphical representation of an XML sequence containing 5 items.

FIG. 2 is a graphical representation of a copy of the XML sequence shown in FIG. 1.

FIG. 3 is a diagram describing the main functional components of a system that uses the method disclosed in this invention.

FIG. 4 is a flow chart that summarizes the main steps of the method disclosed in accordance with the present invention.

FIG. 5 is a flow diagram that illustrates the first embodiment of the processing of input variables.

FIG. 6 is a flowchart that illustrates the processing of output variables.

FIG. 7 is a flow diagram that illustrates a second embodiment of the processing of input variables.

### DETAILED DESCRIPTION

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

A system and method in accordance with the present invention can be implemented in a variety of ways. For example, it can be provided via a computer recordable media, such as a CD, DVD, magnetic disk, floppy disk, hard disk drive within a computer system. Furthermore, it can be downloaded to a computer system that includes a database system from a public or private network.

In spite of the fact that an XML value and a copy of it are not identical, it can be observed that many programs that include by-value assignments to variables of type XML produce the correct results even when some of the copies required by by-value assignment are not performed.

It is therefore an object of this invention to identify conditions under which copy operations in by-value assignments can be avoided without affecting the correctness of the program that contains them. These unnecessary copy operations adversely affect execution performance of the database system where the program is executed.

Overview

A method and system is disclosed to reduce the number of copies that are necessary in order to correctly implement the support of variables of a data type in a procedural language with by-value assignment semantics.

The method and system comprises performing an analysis at routine compilation time to determine which of the statements in the routine would produce wrong results if copies required by by-value assignments are not done. At compilation time such statements are marked as being “copy-sensitive”.

The method and system further comprises utilizing a “lazy copy” strategy at runtime to avoid unnecessary copies: instead of always creating copies as part of assignment operations, the assignment operation simply makes the variable refer to the value produced by the RHS of the assignment, and marks the variable as being in copy-pending state. The copy is delayed until the variable is used in a copy-sensitive statement. If the variable is never used in a copy-sensitive statement, then the copy will never be made, which results in a performance improvement. When a variable in copy-pending state is about to be used in a copy-sensitive statement, a copy is made, the variable is updated to refer to the copy, and the new value is used as argument to the statement.

Copy-Sensitive and Copy-Insensitive Statements

Intuitively, a statement is copy-sensitive when the value it computes or the effect it produces can be affected by one or more of its XML arguments being copied prior to executing it.

In order to provide a more precise definition of copy-sensitive statement, the notion of deep equality between two XML values, as defined in the “XQuery 1.0 and XPath 2.0 Functions and Operators” standard (http://www.w3.org/TR/xquerv-operators) is utilized. Briefly, two XML values are deep equal if their contents and structure are identical, but their nodes may not have the same identity.

First a copy-sensitive operation is defined, and then that definition will be utilized to define what a copy-sensitive statement is.

Let F(X) be an operation with an XML parameter, and let V′ represent a copy of XML value V. Operation F is copy-sensitive if, for some XML value x, F(x) is not deep equal to F(x′). Similarly, an XML operation F(X,Y) with two XML parameters is copy-sensitive if, for some values x and y, the values F(x, y), F(x′, y), F(x, y′) and F(x′, y′) are not all deep equal among themselves. And so on, for XML operations with three or more XML parameters.

On the other hand, an statement is copy-sensitive when it contains a copy-sensitive operation and one or more of its input variables of type XML are used in the arguments passed to this operation. Otherwise, a statement is copy-insensitive.

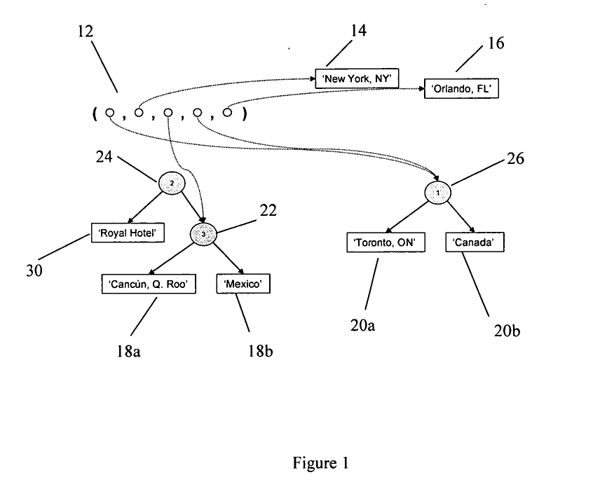

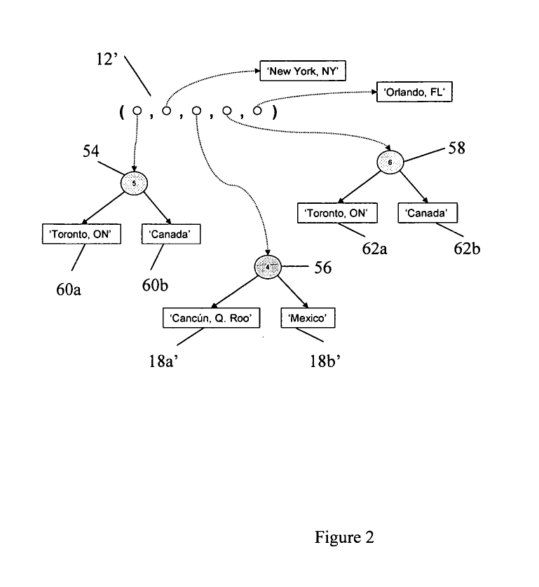

For example, let V1 and V2 be variables of type XML whose values are the ones depicted in FIG. 1 and FIG. 2, respectively (therefore, V2 is a copy of V1). Consider the following statement:
SET V3=XMLQUERY(‘$V1[1] is $V1[4]’ passing V1 by ref as V1) BY VALUE; Statement 1

Statement 1 invokes the XMLQUERY function using variable V1 as argument and assigns the result to variable V3. XMLQUERY is part of SQL/XML and it allows the user to manipulate XML values using XQuery expressions. In this case, the XQuery expression (enclosed in single quotes) uses the “is” predicate to compare the identities of the first and the fourth items of V1, and the result of the comparison (either “true” or “false”) is assigned to variable V3. Given that the first and fourth items of V1 are duplicates (refer to FIG. 1), the value assigned to V3 is “true”.

Statement 2, shown below, is similar to Statement 1, except that it uses V2 as input, instead of V1.
SET V3=XMLQUERY(‘$V2[1] is $V2[4]’ passing V2 by ref as V2) BY VALUE; Statement 2
In this case, the value assigned to V3 is “false”, because the first and fourth elements of V2 are nodes with different identities.

These examples thus illustrate that XMLQUERY is a copy-sensitive operation. Furthermore, both Statement 1 and Statement 2 are copy-sensitive statements, as variables V1 and V2 are input XML variables used as arguments to XMLQUERY.

Now consider the following statement, which uses the SQL/XML XMLCONCAT function to concatenate two XML values:
SET V3=XMLCONCAT(V1, V2) BY VALUE; Statement 3

The XMLCONCAT function is copy-insensitive as, for arbitrary values x and y, XMLCONCAT(x, y) is always deep equal to XMLCONCAT(x′, y), XMLCONCAT(x, y′) and XMLCONCAT(x′, y′).

Therefore, Statement 3 is copy-insensitive as well.

Similarly, Statement 4 and Statement 5 shown below are copy-insensitive as, even though they have XML input variables, they do not contain XML operations
INSERT INTO xml_values VALUES(V1); Statement 4
SET V1=V2 BY VALUE; Statement 5
In Statement 4, assume that xml_values is a table with a single column of type XML. Statement 4 simply inserts the value of V1 into table xml_values. Statement 5, on the other hand, copies V1 into V2.

The subset of copy-sensitive operations in the current version of the SQL/XML standard includes XMLQUERY, XMLEXISTS and XMLTABLE. The subset of operations in SQL/XML that are not copy-sensitive includes XMLPARSE, XMLCONCAT and XMLELEMENT.

Method to Reduce the Number of Copies

To describe the features of the invention in more detail refer now to the following discussion in conjunction with the accompanying Figures.

First, it is assumed that the copy-sensitive XML operations in the language have been identified as per the definition of copy-sensitive operation given above, and that the information regarding which operations are copy-sensitive is available to the compiler in the form of a data structure. This data structure could have, for example, an entry for each XML operation available in the language, and the entry for a given operation would indicate “true” if the operation is copy-sensitive and “false” otherwise.

The compiler receives a routine and processes each of the statements in the routine. For each statement with XML input variables, the compiler analyzes each of the operations contained in the statement. If any of these operations is copy-sensitive, and if any of the XML input variables of the statement is used in the arguments passed to this operation, the compiler marks the statement as being copy-sensitive. Performing this kind of analysis is within the typical tasks that a compiler can do, so it will not be described in further detail, so as not to obscure the overall description.

Note: from this point forward, the word “assignment” will refer to assignment with by-value semantics, unless otherwise specified.

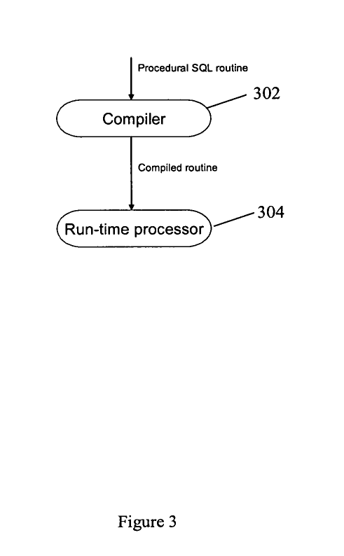

Referring to FIG. 3, once a routine has been compiled via the compiler 302, it is passed to the run-time processor 304, which executes the statements in the routine. Note that a compiler in a real database system would normally store the compiled routine into some form of routine library or catalog. For simplicity, we have omitted this from our diagram, as it does not affect this exposition.

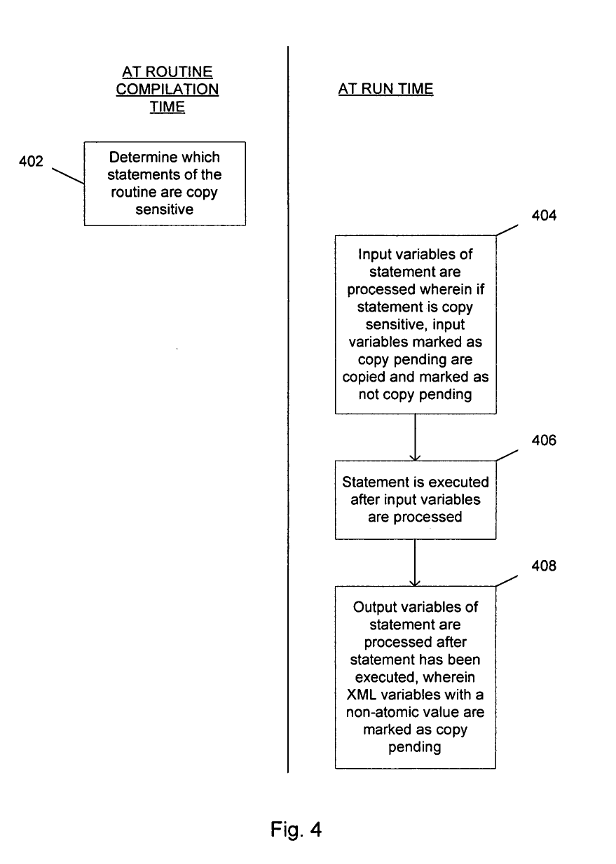

FIG. 4 summarizes the main steps of the method disclosed in the present invention. Referring to FIG. 4, first at routine compilation time it is determined which statements of the routine are copy-sensitive, via step 402. Next, at run time for each statement, the following steps are performed. Input variables of the statement are processed wherein, if the statement is copy-sensitive, the input variables marked as copy-pending are copied and marked as not copy-pending, via step 404. Then the statement is executed after the input variables are processed, via step 406. Finally, the output variables of the statement are processed after the statement has been executed, wherein XML variables with a non-atomic value are marked as copy-pending, via step 408.

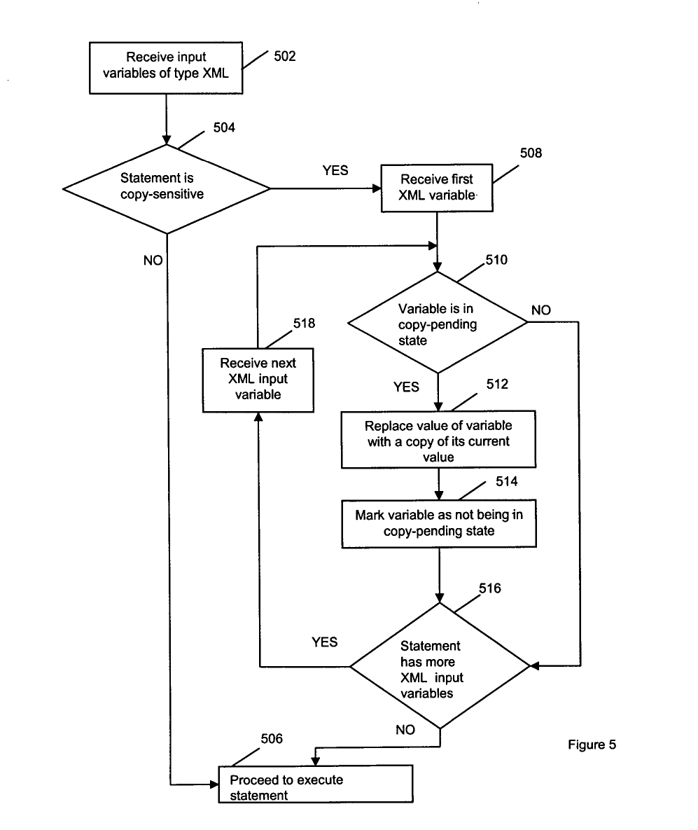

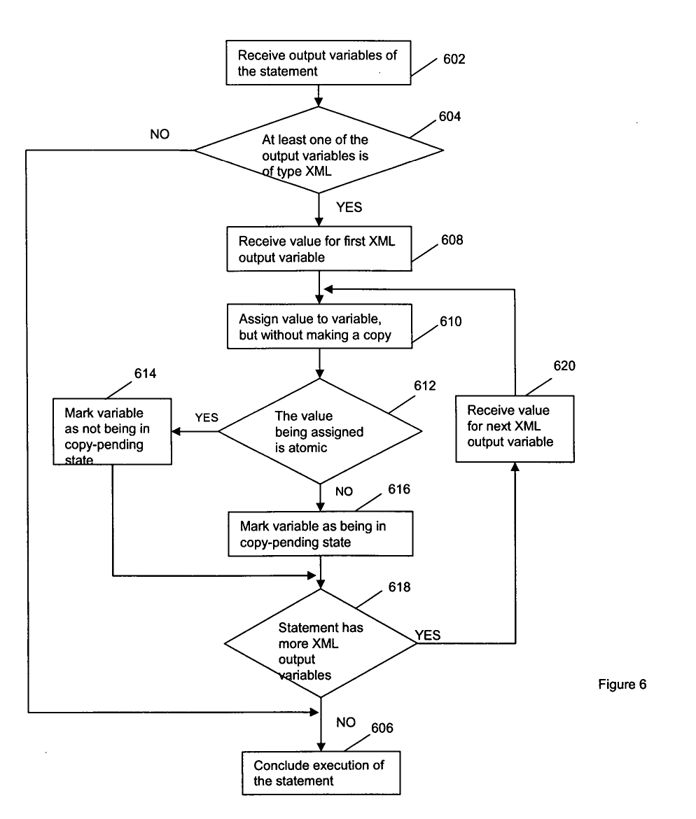

The processing of XML input and of XML output variables referred to in FIG. 4 are further described in the flowcharts shown in FIGS. 5 and 6, respectively.

FIG. 5 is a flow diagram that illustrates a first embodiment of the processing of input variables. As is seen, input variables of type XML are received, via step 502. Next, it is determined if the statement is copy-sensitive, via step 504. If the statement to be executed is not copy-sensitive, it will not be necessary to create a copy of any of the XML variables it uses, thereby providing significant performance benefits. The statement can then be executed, via step 506. On the other hand, if it is determined that the statement is copy-sensitive, via step 504, then a first XML variable is received, via step 508. It is then determined if the input XML variable is in a copy-pending state, via step 510.

If the variable is in a copy-pending state, then it will need to be copied prior to the execution of the statement, via step 512. Once a copy of a variable is created, the variable is marked as not being in a copy-pending state any longer, via step 514, and therefore future uses of this variable will not trigger another “lazy copy”.

It is then determined if the statement has more XML input variables, via step 516. If not, then the statement is executed, via step 506. If yes, then a next XML input variable is received, via step 518. Returning to step 510, if it is determined that the variable is not in copy-pending state, via step 510, then it is determined whether the statement has more XML input variables, via step 516. If not, then the statement is executed, via step 506. If yes, then the next XML input variable is received, via step 518. These steps 510-516 continue until all of the XML input variables of the statement have been processed, then proceed to execute the statement, via step 506.

FIG. 6 is a flowchart that illustrates the processing of output variables of the statement. As is seen, first the output variables of the statement are received, via step 602. It is then determined if a statement has one or more output XML variables, via step 604. If not, then proceed to conclude the execution of the statement, via step 606. If yes, then the value for the first XML output variable is received, via step 608.

Next, a value is assigned to a variable, but without making a copy, via step 610. Then it is determined if the value being assigned is atomic, via step 612. If yes, the variable is marked as not being in copy-pending state, via step 614, and the process proceeds to step 618 to determine if the statement has more XML output variables.

Returning to step 612, if the value being assigned is not atomic, then the variable is marked as being in copy-pending state, via step 616. It is then determined if the statement has more XML output variables, via step 618. If yes, then the value is received for the next XML output variable, via step 620. If not, proceed to the execution of the next statement, via step 606. Note that variables that contain atomic XML values are never marked as being in a copy-pending state. These steps 610-618 continue until all of the XML output variables of the statement have been processed, then proceed to conclude the execution of the statement, via step 606.

Avoiding Additional Copies

When the XML values manipulated in a routine are nodes (as opposed to sequences with more than one item), a simple modification of the method presented above makes it possible to avoid additional copies, as explained hereinbelow.

When a node with no parent is copied, the only possible difference between the original value and the copy is in node identities. On the other hand, node identities can affect the result of an operation only when nodes from two different trees are compared. This is because the only operation on identities is equality comparison, and the identities of two nodes belonging to the same tree are always different. Therefore, when executing a statement with a single input variable, if the value of the variable is a node with no parent, then it is not necessary to create a copy of this variable prior to executing the statement, even if the variable is in copy-pending state. An example of a node with no parent is node 26 in FIG. 1, which represents the city of Toronto.

If the value of the input variable is a node with a parent node (refer node 22 in FIG. 1), then an XML operation could use that parent node to compute its result. Therefore, that operation could produce a different result when the value of the input variable is a copy of the node (refer to node 56 in FIG. 2).

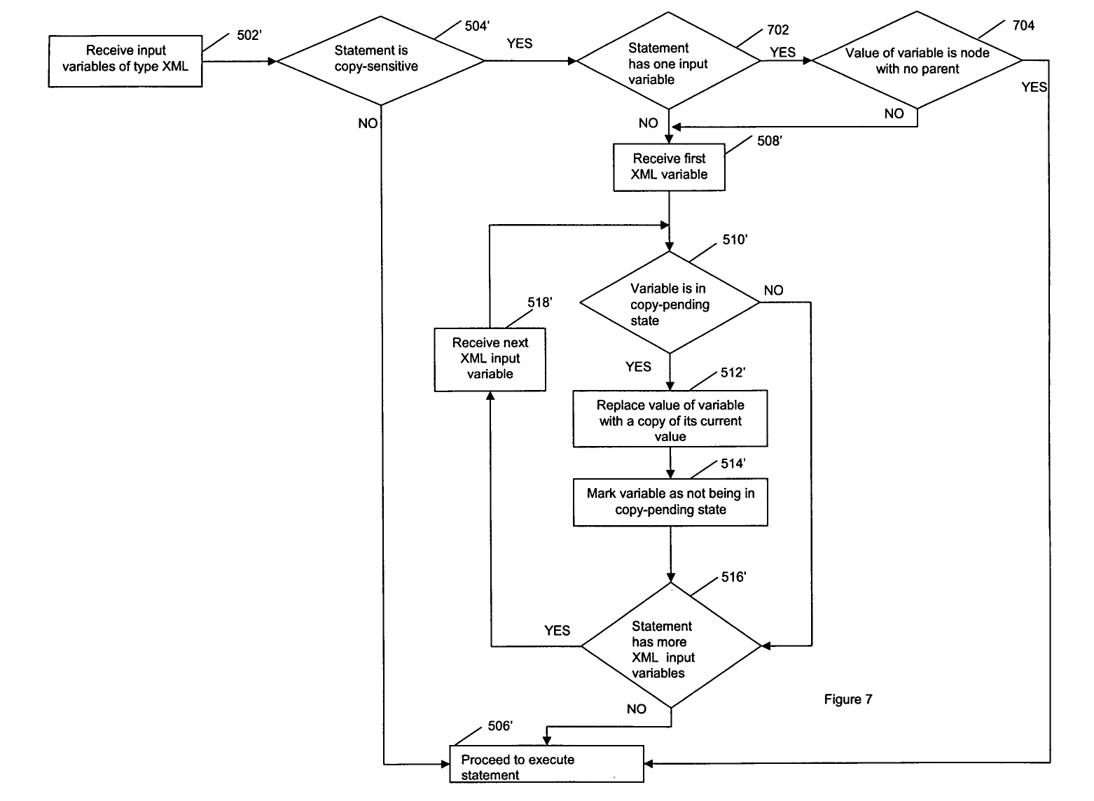

FIG. 7 is a flow diagram that illustrates a second embodiment of processing input variables. As is seen, when compared to FIG. 5, FIG. 7 has two additional steps 702 and 704. If the statement is copy-sensitive, in step 702 it is determined if the statement has exactly one input variable. If the statement has more than one variable, then proceed to step 508′ and execute the flow diagram in the same manner as described in FIG. 5. However, if there is exactly one input variable, then it is determined if the value of the variable is a node with no parent, via step 704. If the value of the variable is not a node with no parent, then proceed to step 508′ and execute the flow diagram in the same manner as FIG. 5. However, if the value is a node with no parent then proceed to execute the statement, via step 506′.

Although the present invention has been described in accordance with the embodiments shown, one of ordinary skill in the art will readily recognize that there could be variations to the embodiments and those variations would be within the spirit and scope of the present invention. For example, a system and method in accordance with the present invention is described in the context of SQL/XML and SQL/PSM. One of ordinary skill in the art recognizes that a variety of other procedural languages or other data types could be utilized and their use would be within the spirit and scope of the present invention. Specifically, any procedural language with by-value assignment semantics on variables of XML or a similar data type with a copy operation such that the copy of a value is not identical in every respect to the original value could benefit from a system and method in accordance with the present invention.

Accordingly, many modifications may be made by one of ordinary skill in the art without departing from the spirit and scope of the appended claims.

What is claimed is:

1. A method for reducing the number of copies in the execution of a routine, the method comprising:
at routine compilation time:
determining which statements in the routine are copy-sensitive; and at run-time for each statement in the routine:
processing of a plurality of input variables of the statement wherein if the statement is copy-sensitive, the plurality of input variables marked as copy-pending are copied and marked as not copy-pending;
executing the statement after the plurality of input variables are processed; and
processing of a plurality of output variables of the statement after the statement has been executed, wherein the plurality of output variables with a non-atomic value are marked as copy-pending.

2. The method of claim 1 wherein the processing of the plurality of input variables for a copy-sensitive statement comprises:
receiving an input variable of the statement;
determining if the variable is in copy-pending state;
replacing the current value of the variable with a copy of the current value if the variable is in copy-pending state;
marking the variable as not being in copy-pending state;
determining if the statement has more input variables;
repeating the above steps until all of the input variables are processed; and
executing the statement after all of the input variables are processed.

3. The method of claim 1 wherein the each of the statements comprises a statement in a routine written in an SQL procedural language.

4. The method of claim 1 wherein the variables marked as copy-pending comprise XML variables.

5. The method of claim 2 wherein the processing of the plurality of output variables for each of the statements comprises:
concluding the execution of the statement if the statement has no output variables; otherwise
receiving a value for the first output variable;
assigning a value to the variable, but without making a copy;
marking the variable as being in copy-pending state if the value being assigned to the variable is not atomic;
marking the variable as not being in copy-pending state if the value being assigned to the variable is atomic;
determining if the statement has more output variables;
repeating the above steps until all of the output variables are processed; and
concluding the execution of the statement when all output variables are processed.

6. The method of claim 5 wherein the statement comprises a statement in a routine written in an SQL procedural language.

7. The method of claim 2 wherein if a value of an input variable is a node with no parent, then it is not necessary to create a copy of the variable prior to executing the statement, even if the variable is in a copy-pending state.

8. A computer readable medium containing program instructions for reducing the number of copies in the execution of routines, the program instructions comprising:
at routine compilation time:
determining which statements in the routine are copy-sensitive; and at run-time for each statement in the routine:
processing of a plurality of input variables of the statement wherein if the statement is copy-sensitive, the plurality of input variables marked as copy-pending are copied and marked as not copy-pending;
executing the statement after the plurality of input variables are processed; and
processing of a plurality of output variables of the statement after the statement has been executed, wherein output variables with a non-atomic value are marked as copy-pending.

9. The computer readable medium of claim 8 wherein the processing of the plurality of input variables for a copy-sensitive statement comprises:
receiving an input variable of the statement;
determining if the input variable is in copy-pending state;
replacing a value of the variable with a copy of the current value if the input variable is in copy-pending state;
marking the variable as not being in copy-pending state;
determining if the statement has more input variables;
repeating the above steps until all of the input variables are processed; and
executing the statement after all of the input variables are processed.

10. The computer readable medium of claim 8 wherein each of the statements comprises a statement in a routine written in an SQL procedural language.

11. The computer readable medium of claim 8 wherein the variables marked as copy-pending comprise XML variables.

12. The computer readable medium of claim 9 wherein the processing of output variables for the statements comprises:
concluding the execution of the statement if the statement has no output variables; otherwise
receiving a value for the first output variable;
assigning a value to the variable, but without making a copy;
marking the variable as being in copy-pending state if the value being assigned to the variable is not atomic;
marking the variable as not being in copy-pending state if the value being assigned to the variable is atomic;
determining if the statement has more output variables;
repeating the above steps until all of the output variables are processed; and
concluding the execution of the statement when all output variables are processed.

13. The computer readable medium of claim 12 wherein the statement comprises a statement in a routine written in an SQL procedural language.

14. The computer readable medium of claim 9 wherein if a value of an input variable is a node with no parent, then it is not necessary to create a copy of the variable prior to executing the statement, even if the variable is in a copy-pending state.

15. A system comprising:
a compiler, the compiler including a mechanism for determining which statements in a routine are copy-sensitive; and
a run-time processor including mechanisms for:
processing of a plurality of input variables of a statement in a routine, wherein if the statement is copy-sensitive, the plurality of input variables marked as copy-pending are copied and marked as not copy-pending;
executing a statement in a routine after its input variables have been processed; and
processing of a plurality of output variables of a statement in a routine after the statement has been executed, wherein output variables with a non-atomic value are marked as copy-pending.

16. The system of claim 15 wherein the mechanism for processing of the plurality of input variables for a statement comprises mechanisms for:
receiving an input variable of the statement;
determining if the input variable is in copy-pending state;
replacing a value of the variable with a copy of the current value if the input variable is in copy-pending state;
marking the replaced value as not being in copy-pending state;
determining if the statement has more input variables;
repeating the above steps until all of the input variables are processed; and
executing the statement after all of the input variables are processed.

17. The system of claim 15 wherein the variables marked as copy-pending comprise XML variables.

18. The system of claim 15 wherein the statement comprises a statement in a routine written in an SQL procedural language.

19. The system of claim 16 wherein the mechanism for processing of the plurality of output variables for the statement comprises mechanisms for:
concluding the execution of the statement if the statement has no output variables; otherwise
receiving a value for the first output variable;
assigning a value to the variable, but without making a copy;
marking the variable as being in copy-pending state if the value being assigned to the variable is not atomic;
marking the variable as not being in copy-pending state if the value being assigned to the variable is atomic;
determining if the statement has more output variables;
repeating the above steps until all of the output variables are processed; and
concluding the execution of the statement when all output variables are processed.

20. The system of claim 19 wherein the statement comprises a statement in a routine written in an SQL procedural language.

21. The system of claim 15 wherein if a value of a variable is a node with no parent, then it is not necessary to create a copy of the variable prior to executing the statement, even if the variable is in a copy-pending state.
